(19) United States
(12) Patent Application Publication
(10) Pub. No.: US 2020/0267221 A1
(43) Pub. Date: Aug. 20, 2020

(54) METHOD, SYSTEM, AND DEVICE FOR CONTROLLING AN INTERNET OF THINGS DEVICE

(71) Applicant: Alibaba Group Holding Limited, George Town (KY)

(72) Inventor: Zhijun Yuan, Hangzhou (CN)

(21) Appl. No.: 16/796,234

(22) Filed: Feb. 20, 2020

Related U.S. Application Data
(63) Continuation-in-part of application No. PCT/CN2018/101013, filed on Aug. 17, 2018.

(30) Foreign Application Priority Data
Aug. 24, 2017 (CN) 201710736674.1

(51) Int. Cl. H04L 29/08; G16Y 40/30; G06F 40/205; G06F 3/0484

(52) U.S. Cl. CPC H04L 67/125; G06F 3/0484; G06F 40/205; G16Y 40/30

(57) ABSTRACT

The present application discloses a method, device, and system for controlling an Internet of Things (IoT) device. The method includes receiving a signal from an Internet of Things (IoT) device; obtaining a device identifier (ID) based at least in part on the signal, determining interface data corresponding to the IoT device based at least in part on the device ID, and providing a control interface that is configured to control the IoT device, the control interface being provided based at least in part on the interface data.

### CROSS REFERENCE TO OTHER APPLICATIONS

This application is a continuation-in-part of and claims priority to International (PCT) Application No. PCT/CN2018/101013 entitled DEVICE CONTROL METHOD, DEVICE, TERMINAL DEVICE AND OPERATING SYSTEM, filed Aug. 17, 2018 which is incorporated herein by reference for all purposes, which claims priority to China Application No. 201710736674.1 entitled DEVICE CONTROL METHOD, MEANS, TERMINAL DEVICE AND OPERATING SYSTEM, filed Aug. 24, 2017 which is incorporated herein by reference for all purposes.

### FIELD OF THE INVENTION

The present application relates to a field of terminal technology. In particular, the present application relates to a technique for associating devices, including a method, a system, a device, an Internet of Things operating system, or other means for associating devices.

### BACKGROUND OF THE INVENTION

As Internet of Things (IoT) technology develops and IoT devices become widespread, users often wish to control Internet of Things devices with the users' phones or other mobile terminals to make operation of the various IoT devices faster and more convenient.

However, a great diversity of IoT devices currently exist. Each of the IoT devices differs with respect to type, manufacturer, or some other characteristic. Further, the connection and control methods for each IoT device and control device are often different. For example, the connection and control method can vary according to type, manufacturer, or some other characteristic of the IoT device. Moreover, a corresponding application (app) is generally required to downloaded and installed in order to for the IoT device(s) to be used. As a result, many rarely used apps (e.g., pertaining to various IoT device(s)) are installed on a user' phone, and such apps can take up a large amount of system resources.

Accordingly, there is a need to for a method, system, and device for connecting and/or controlling TOT devices having various characteristics (e.g., different types, different manufacturers, etc.).

### BRIEF DESCRIPTION OF THE DRAWINGS

Various embodiments of the invention are disclosed in the following detailed description and the accompanying drawings.

FIG. 1 is a diagram of a connection between an Internet of Things (IoT) device and a control device according to various embodiments of the present application.

FIG. 2 is a diagram of a system with a terminal and an air-conditioning device and a connection and interaction therebetween according to various embodiments of the present application.

FIG. 3 is a flowchart of method for controlling a device according to various embodiments of the present application.

FIG. 4 is a diagram of a system of devices and a connection of the devices to a terminal according to various embodiments of the present application.

FIG. 5 is a diagram of processing for management of an Internet of Things (IoT) device according to various embodiments of the present application.

FIG. 6 is a diagram of a parsing engine according to various embodiments of the present application.

FIG. 7 is a flowchart method for controlling a device according to various embodiments of the present application.

FIG. 8 is a functional diagram of a computer system according to various embodiments of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

To make the above-described objectives, features, and advantages of the present application plainer and easier to understand, the present application is explained in further detail below in light of the drawings and specific embodiments.

As used herein, a “terminal” generally refers to a device comprising one or more processors. A terminal can be a device used (e.g., by a user) within a network system and used to communicate with one or more servers. According to various embodiments of the present disclosure, a terminal includes components that support communication functionality. For example, a terminal can be a smart phone, a server, a machine of shared power banks, information centers (such as one or more services providing information such as traffic or weather, etc.), a tablet device, a mobile phone, a video phone, an e-book reader, a desktop computer, a laptop computer, a netbook computer, a personal computer, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), a kiosk such as a vending machine, a smart home appliance, vehicle-mounted mobile stations, or the like. A terminal can run various operating systems.

As used herein an Internet of Things (IoT) device is a terminal that can communicate data with one or more other terminals such as over one or more networks or via a connection (e.g., a Bluetooth connection, etc.). An IoT device can communicate data with the one or more other terminals with or without human interaction (e.g., without human-to-human or human-to-computer interaction). An IoT device can have a corresponding unique identifier. As an example, an IoT device can be implemented in a smart home (e.g., the IoT device can be an appliance, etc.).

In some embodiments, an IoT device is a terminal such as a mobile phone, a tablet, or a wearable device (e.g., a smart watch). An IoT device can support features with respect to at least audio, video, or data. In some embodiments, an IoT device is implemented with a screen that is configured to display an IoT device interface. The screen can be a touch screen or a non-touch screen. The terminal can implement various operating systems such as iOS, Android, or YunOS. IoT devices can be implemented in an Internet of Things system. IoT systems can include smart televisions, smart routers, door security systems, lighting systems, other home devices, smart refrigerators, smart ovens, smart rice cookers, and other kitchen appliances, vehicle-mounted devices, and various other smart devices.

As used herein, a “signal” refers to a data carrier in the device. The signal can include device data and device-received data. Device data includes software and hardware data in the device (e.g., data generated by the device), such as device software interaction instruction data, sensor signals, and various interface data. Device-received data includes various instruction data and hardware and interface data received by the device (e.g., data received from another device, etc.). For example, an IoT device that receives interface data pertaining to a status of earphones connection (e.g., information indicating the plugging in or connection of earphones to the IoT device) could call (e.g., invoke and/or execute) a playing application (app) to play audio data such as a song. Thus, connection and interaction with IoT devices can be implemented through signals. As an example, an IoT device receives an external Bluetooth signal and then connects to the device (e.g., an IoT device) associated with the external Bluetooth signal (e.g., the corresponding Bluetooth earphones or other Bluetooth device). As another example, an IoT device can communicate an instruction to an air-conditioning unit to instruct the air-conditioning unit to operate in accordance with one or more conditions (e.g., to start in response to receiving temperature data from a weather app). Signals include signals received by terminal devices from IoT devices. Such signals received by terminal devices from IoT devices can include IoT device-related information and to-be-processed data, including, for example, device ID and signal data such as temperature signals, movement signals, and other such Internet of Things device signal data. Signals can also include data such as device type and device address (e.g., an IP address, a Media Access Control (MAC) address, etc.), a location, a manufacturer, a serial number, etc.

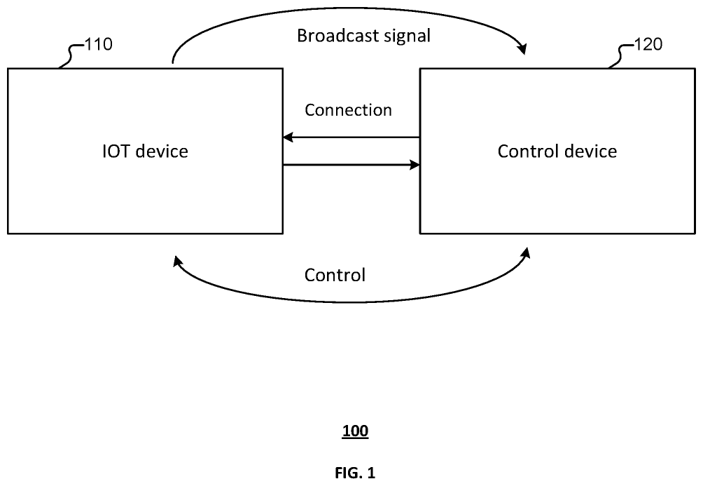

FIG. 1 is a diagram of a connection between an IoT device and a control device according to various embodiments of the present application.

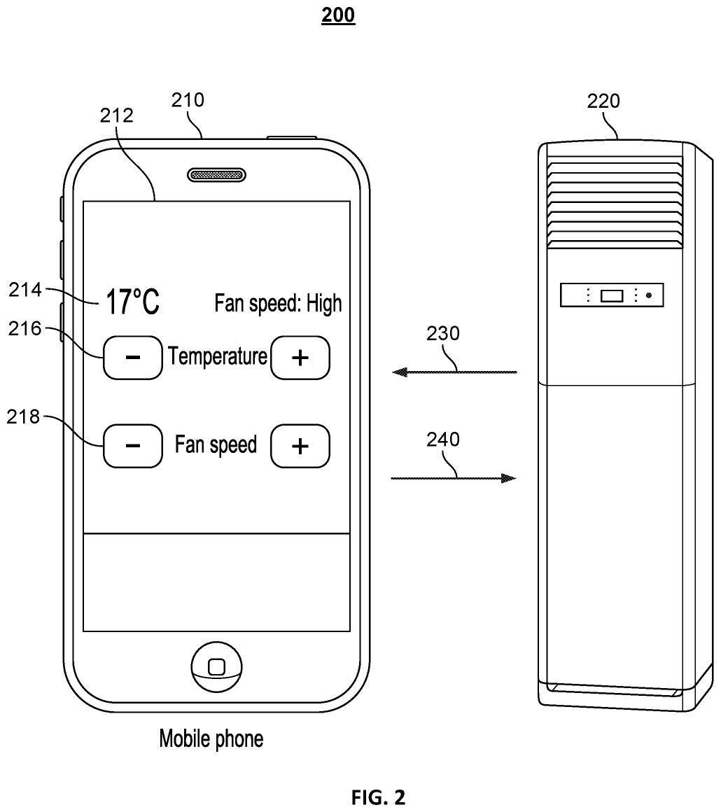

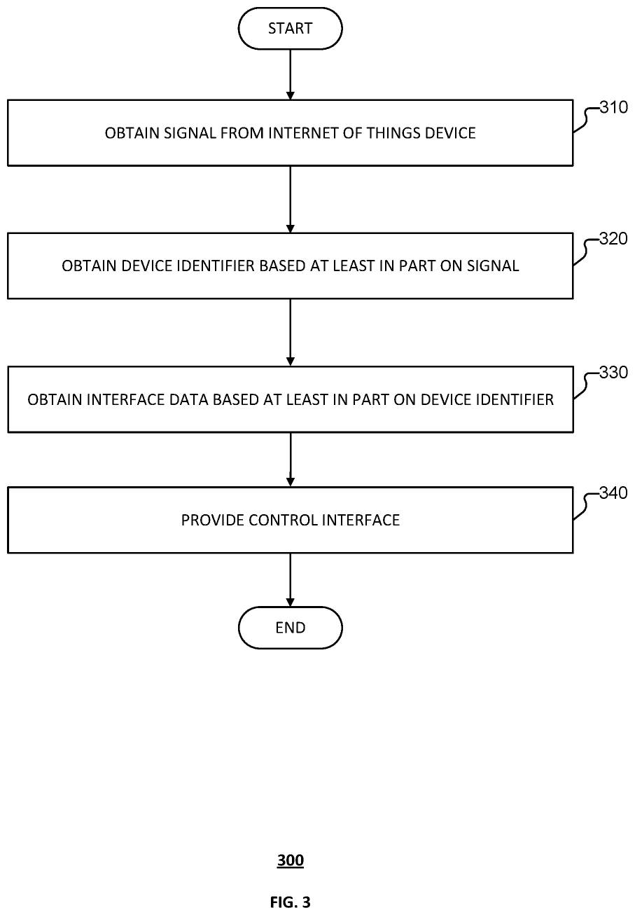

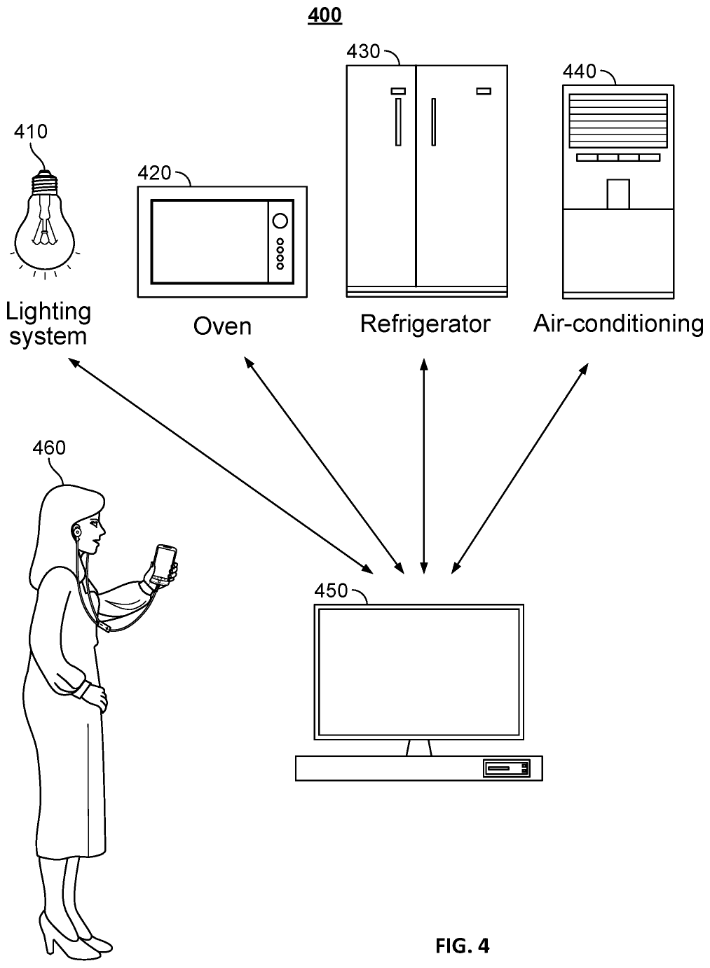

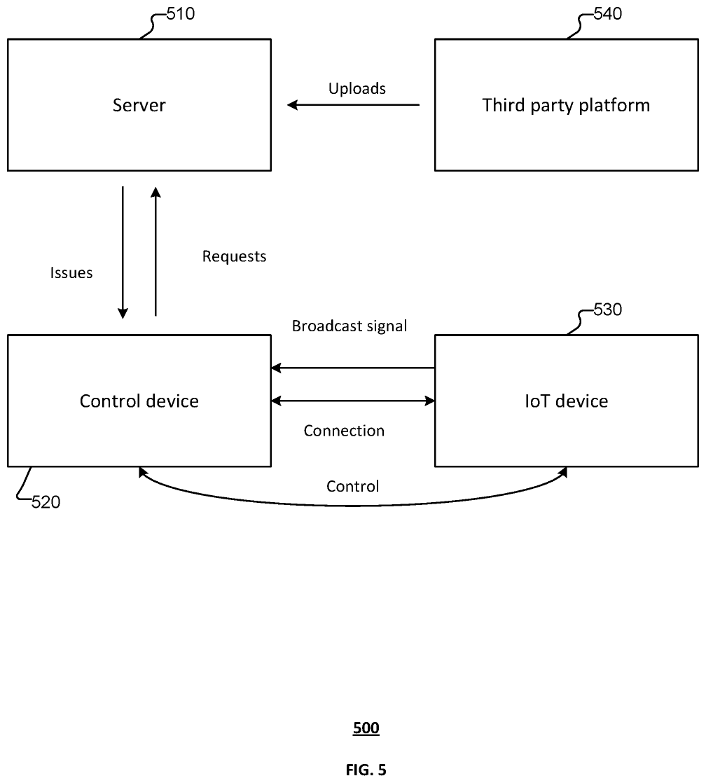

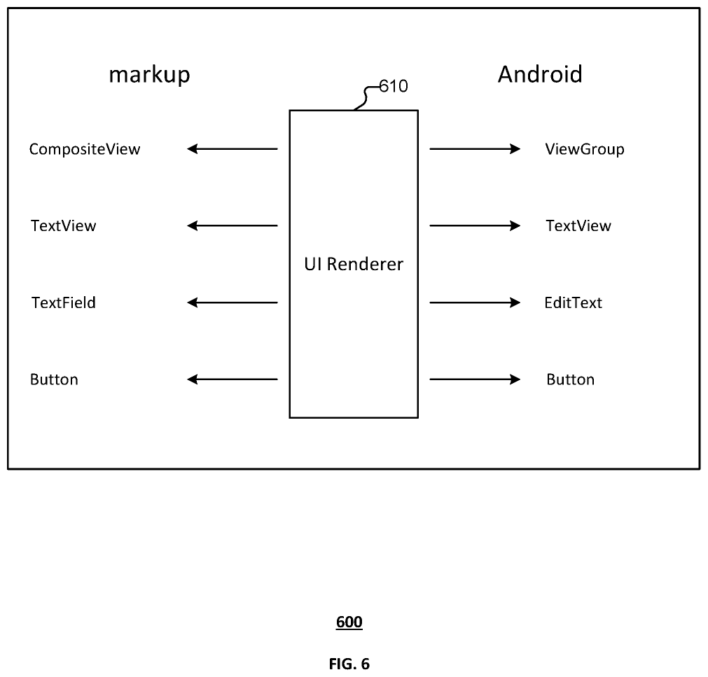

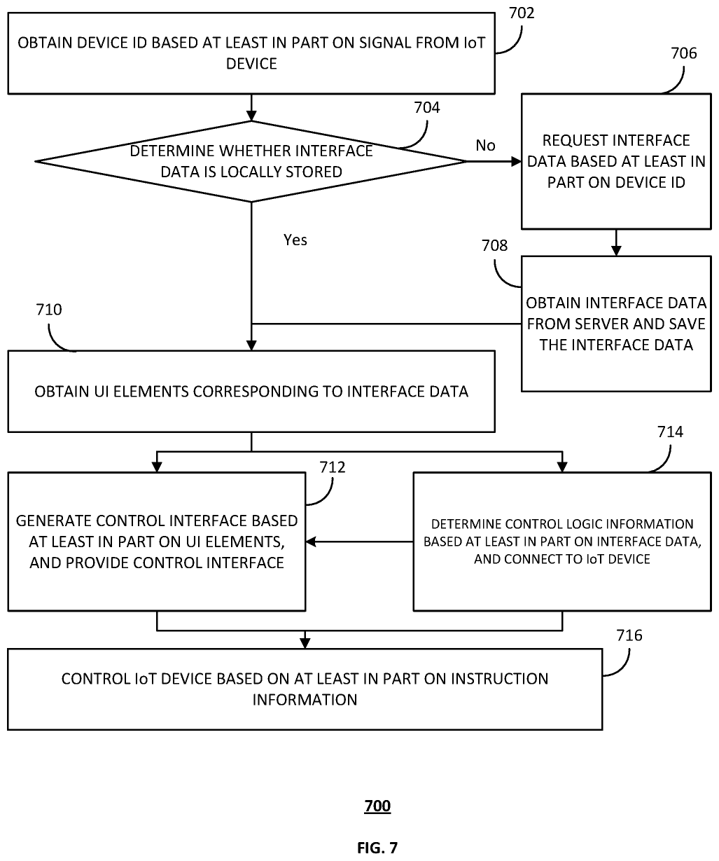

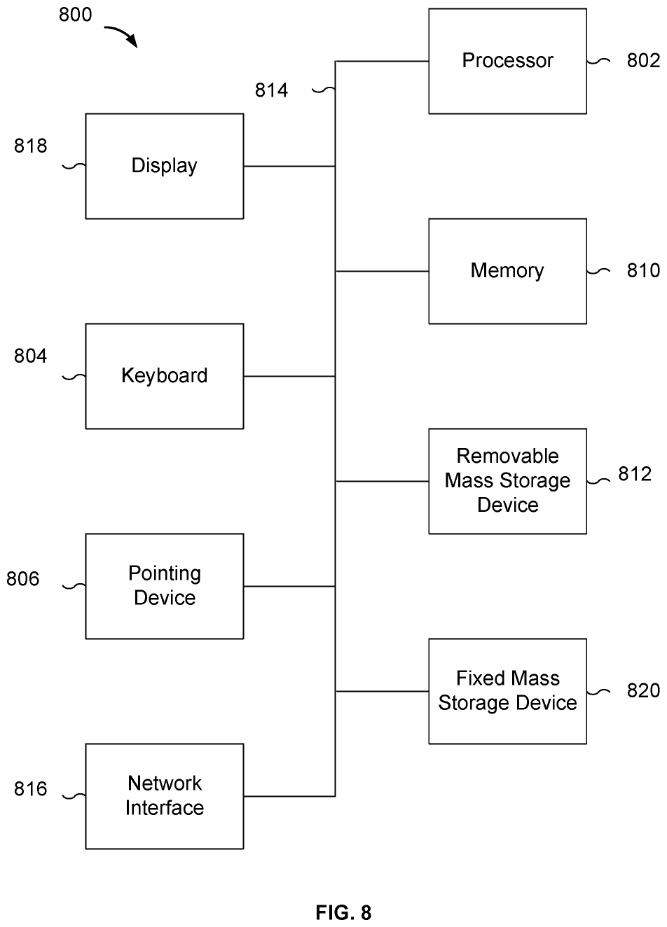

Referring to FIG. 1, system 100 is provided. According to various embodiments, system 100 comprises IoT device 110 and control device 120. FIG. 1 illustrates a connection between IoT device 210 and control device 220. System 100 can be implemented in connection with system 200 of FIG. 2, system 400 of FIG. 4, system 500 of FIG. 5, and/or parsing engine 600 of FIG. 6. System 100 can implement process 300 of FIG. 3, and/or process 700 of FIG. 7. System 100 can be implemented at least in part by computer system 800 of FIG. 8.

According to various embodiments, IoT device 110 and control device 120 are connected via one or more networks or via a connection between IoT device 110 and control device 120 (e.g., a Bluetooth connection or other established connection). IoT device 110 and control device 120 can interact after connecting with each other. In some embodiments, one of IoT device 110 and control device 120 can control the other device such as via communicating an instruction across the connection between IoT device 110 and control device 120. IoT device 110 and control device 120 can perform one or more functions in response to receiving information (e.g., a signal) from the other.

According to various embodiments, IoT device 110 broadcasts and/or communicates (e.g., via an established communication channel, over a network, etc.) message signals via Bluetooth and/or WiFi. Other wireless communication protocols can be implemented for communication information between IoT device 110 and control device 120. Control device 120 can receive the message signals communicated by IoT device 110. For example, control device 120 can monitor (e.g., poll) for broadcast signals being communicated by IoT device 110 and obtain information from detected broadcast signals. As another example, control device 120 receives the message signals via an established connection between IoT device 110 and control device 120.

In response to receiving a signal from IoT device 110, control device 120 can obtain a device ID. For example, control device 120 can obtain the device ID from within the signal. The signal can be formatted according to a predefined format or protocol, and control device 120 can obtain device ID from a predefined portion of the signal. In some embodiments, the device ID is unique with respect to a particular device (e.g., no other device at least within the system 100 has a same device ID. In some embodiments, the device ID represents one type of device (e.g., the device ID can be indicative of a type of device). For example, the device ID can be unique with respect to a particular type of device. The type of device can be set according to preferences or settings of system 100, IoT device 110, or a user of IoT device 110. Types of devices can be differentiated according to device categories, different brands within the same category of device, device models corresponding to each brand, etc. Other characteristics pertaining to a device can be used to differentiate across types of the device. Thus, a type of device with the device ID can be determined based at least in part on the device ID, and data corresponding to the device can be obtained based at least in part on the type of device. For example, characteristics of the device can be obtained based at least on part on the device ID, or configuration settings for the device can be obtained, etc.

According to various embodiments, interface data used to describe a control interface of an Internet of Things device describes or characterizes corresponding control logic information. For example, the interface data can describe an interface and control logic corresponding to the IoT device according to prespecified protocol or language such as XML. In some embodiments, device data is published on a corresponding server (e.g., after the device data is developed by a developer). The interface data can also be published on a corresponding server. The device data can include the interface data. Thus, if a corresponding Internet of Things device is to be used, the IoT device can be controlled based at least in part on the interface data. For example, a control device connected to the IoT device (or in communication with the IoT device) can obtain the interface data corresponding to the IoT device and control (e.g., communicate one or more instructions) to the IoT device according to the interface data. In some embodiments, the interface data is obtained based at least in part on the device ID for the corresponding device. For example, the device ID serves as a basis to look up the interface data (e.g., interface data downloaded from a server) of the corresponding IoT device. As another example, the device ID is used in connection with looking up locally stored interface data for the IoT device. The interface data can be parsed (e.g., by the control device), and the interface data can serve as a basis to obtain various UI controls (e.g., UI controls by which the IoT device can be controlled). The UI controls can be used in connection with providing a corresponding control interface. For example, a control interface for the IoT device is displayed based at least in part on the UI controls for the IoT device. In some embodiments, the control interface is provided by the control device. In some embodiments, the control interface can be used in connection with providing a connection (e.g., establishing a connection) with the IoT device. Based at least in part on the control interface and/or an interaction with the control interface, a user can control the IoT device. For example, the user can input one or more inputs to the control interface for controlling the IoT device.

FIG. 2 is a diagram of a system with a terminal and an air-conditioning device and a connection and interaction therebetween according to various embodiments of the present application.

Referring to FIG. 2, system 200 is provided. According to various embodiments, system 200 comprises terminal 210 and IoT device 220. Terminal 210 can be a mobile terminal such as a mobile phone, a smart watch, a tablet, etc. In embodiments, terminal 210 is a smart thermostat. Terminal 210 can be a control device (e.g., a device used in connection with performing control of one or more IoT devices). IoT device 220 can be an air conditioning device, a heating device, etc. According to various embodiments, system 200 is implemented in connection with implementing temperature control using an interaction between a control device and an IoT device. System 200 can be implemented in connection with system 100 of FIG. 1, system 400 of FIG. 4, system 500 of FIG. 5, and/or parsing engine 600 of FIG. 6. System 200 can implement process 300 of FIG. 3, and/or process 700 of FIG. 7. System 200 can be implemented at least in part by computer system 800 of FIG. 8. For example, one or more of terminal 210 and IoT device 220 comprises a computer system such as computer system 800 of FIG. 8.

According to various embodiments, terminal 210 connects to and controls IoT device 220. Terminal 210 can control IoT device 220 based at least in part on at least one of one or more inputs to terminal 210 from a user (e.g., to a user interface provided by terminal 210), one or more predefined settings based on manufacture settings, one or more predefined user preferences, historical information, information obtained from an app running on terminal 210 (e.g., a weather app), etc. The historical information can be determined based on user behavior, or historical temperature settings (e.g., such a temperature controlled based on time of day, day of the week, presence of a person in an area controlled, etc.). In some embodiments, terminal 210 communicates one or more instructions (e.g., requests to perform a function, etc.) to IoT device 220 in connection with terminal 210 controlling IoT device 220. For example, the one or more instructions can pertain to a fan speed, a temperature, a temperature mode (e.g., heating or cooling), etc. The one or more instructions can include an instruction to change to a particular setting (e.g., a particular fan speed, temperature, etc.), or an instruction to change a particular setting (e.g., to increase fan speed, to decrease fan speed, to increase temperature, to decrease temperature, etc.). In some embodiments, terminal 210 communicates to the IoT device 220 information from which IoT device 220 determines one or more operations to control temperature. For example, terminal 210 communicates to IoT device 220 information associated with outside weather (e.g., a current weather, a weather forecast, etc.). IoT device 220 can determine an operation based on the information. For example, in response to a determination that the outside weather is relatively warm and raining (or expected to rain), IoT device 220 can operate determine whether air-conditioning is turned on, and to turn-on air-conditioning in response to determining that the air-conditioning is not turned-on.

At 230, IoT device 220 communicates data to terminal 210. The data can be communicated via a broad cast signal, or via a connection established between IoT device 220 and terminal 210. In response to receiving the data from IoT device 220, device ID corresponding to IoT device 220 can be obtained. For example, the data communicated to terminal 210 can comprise a device ID, or a device ID can be looked-up based on information comprised in the data. As an example, after the air-conditioning device (e.g., IoT device 220) broadcasts a signal (e.g., via WiFi), the mobile terminal (e.g., terminal 210) can receive the signal. In response to receiving the signal, the mobile terminal obtains the device ID based at least in part on the signal (e.g., extracts the device ID from the signal, or uses information within the signal to look-up the device ID, etc.). The mobile terminal uses the device ID in connection with obtaining the interface data corresponding to the air-conditioning device. According to various embodiments, the mobile terminal provides an interface (e.g., a control interface) to a user based at least in part on the interface data. Further in connection with the example provided above, the phone parses the interface data and displays the corresponding control interface. According to various embodiments, the IoT device 220 can be controlled based at least in part on inputs to the control interface. In some embodiments, the phone (e.g., terminal 210) establishes a connection between the phone and the air-conditioning unit based at least in on the control interface.

In some embodiments, the interface (e.g., the control interface) provided to the user comprises one or more of information pertaining to an identifier of the air-conditioning device, information pertaining to an operating mode and/or status of the air-conditioning device, one or more control elements (e.g., buttons, etc.) with which a user input can be input to control the air-conditioning device, information obtained from one or more apps associated with a function of the air-conditioning device (e.g., a current weather or weather forecast obtained from a weather app), etc. As illustrated in FIG. 2, terminal 210 provides control interface 212. Control interface 212 comprises an indication 214 of a current status of the IoT device 220 (e.g., the air-conditioning unit) and/or other operating statuses of the IoT device 220, etc. For example, in the case of the IoT device 220 being an air-conditioning device 220, the indication 214 provided on interface 212 can include the status air-conditioning device such as current temperature (or current temperature at which air-conditioning device is configured to maintain), fan speed (e.g., high, medium, low, etc.), and various other operating statuses. Control interface 212 can include one or more control elements. For example, control interface 212 includes control element 216. Control element 216 includes an up button and a down button for controlling a temperature setting. A user can interact with the control element 216 to adjust the temperature setting of IoT device 220. As another example, control interface 212 includes control element 218. Control element 218 includes an up button and a down button for controlling a fan speed setting. A user can interact with the control element 218 to adjust the setting of the fan speed of IoT device 220. Control interface 212 can include various other control elements. In some embodiments, a control element provided on a control interface is a button, a radial button, a check box, or a slide bar, radial dial. Various other control elements can be implemented on control interface 212. Accordingly, the user can use the control interface 212 to adjust the air-conditioning temperature, fan speed, mode, switch on/off.

According to various embodiments, terminal 210 and IoT device 220 communicate via one or more networks or via an established connection (e.g., a Bluetooth connection established via pairing, etc.). At 230, IoT device 220 can communicate information to terminal 210. As an example, the information can be broadcast by IoT device 220 and obtained by terminal 210. As another example, the information can be sent specifically to terminal 210 (e.g., the information can be communicated in one or more packets having a recipient address corresponding to terminal 210, across an established connection such as a communication channel between terminal 210 and IoT device 220, etc.). At 240, terminal 210 can communicate information to IoT device 220. As an example, the information can be broadcast by IoT device 220 and obtained by terminal 210. As another example, the information can be sent specifically to terminal 210 (e.g., the information can be communicated in one or more packets having a recipient address corresponding to terminal 210).

In some embodiments, the system layer provides capabilities for connection to, and for control of, various types of IoT devices. The system layer can correspond to the operating system layer. Use of the system layer in establishing a connection to an IoT device ensures a quick connection between a terminal (e.g., a control device) and an IoT device. For example, the connection can be near-instantaneous. As an example, the connection between the terminal and the IoT device can be relatively quick or near-instantaneous based at least in part on the implementation of a parsing engine of the operating system, wherein the parsing engine parses the interface data and causes a control interface to be displayed. As an example, the connection between the terminal and the IoT device can be relatively quick or near-instantaneous because an app does not need to be installed in order to connect the terminal and the IoT device. IoT developers can develop and publish features for controlling IoT devices based on the capabilities (e.g., provided by the system layer). The features developed for controlling IoT devices can achieve a native app experience and performance (e.g., by making use of the capabilities provided by the system layer). A an example, a providing of a control interface by the operating system layer (e.g., a parsing engine) displays a UI that is similar to a UI of an app for controlling the IoT device (e.g., an app that would be developed and installed on the device in order to control the IoT device). The features of the control interface provided by such operating system layer can include features that would typically be included in a native app for controlling the IoT device. Moreover, a terminal can quickly connect to and control an IoT device as necessary without a user having to install an app in the application layer, resulting in fewer resources occupied because of app installation in the application layer. Further, the use of the system layer providing the connection to, and control of, an IoT device allows a user to control the corresponding IoT device without having to browse an app store and/or download an appropriate app. As an example, a parsing engine implements the capabilities of connecting to, and controlling, an IoT device. The parsing engine is part of, or otherwise included in, the system layer. The parsing engine can be configured to parse the interface data. After the interface data is obtained by a control device, the interface data is parsed by the parsing engine and displayed as an interface (e.g., a control interface) without having to undergo an installation process in the control device (e.g., the terminal such as a mobile terminal). According to various embodiments, device control and interaction may be implemented through the interface and corresponding scripts. In some embodiments, interface data is developed to comply with the rules of the parsing engine. Developers can define the interface data in a manner that such interface data can be parsed by the parsing engine.

FIG. 3 is a flowchart of method for controlling a device according to various embodiments of the present application.

Referring to FIG. 3, process 300 is provided. Process 300 can be implemented by system 100 of FIG. 1, system 200 of FIG. 2, system 400 of FIG. 4, system 500 of FIG. 5, and/or parsing engine 600 of FIG. 6. Process 300 can be implemented at least in part by computer system 800 of FIG. 8.

At 310, a signal is obtained from an IoT device. In some embodiments, the signal is obtained by a control device. The control device can be a terminal such as a mobile terminal, etc. In some embodiments, the control device obtains the signal via a broadcast signal. For example, the IoT device can broadcast the signal, and the control device can monitor for broadcasted signals and obtain the signal (e.g., upon detecting the broadcasted signal). As another example, the IoT device communicates the signal via an established connection between the IoT device and the control device.

According to various embodiments, the signal comprises information that is formatted according to a predefined format. The predefined format can be based at least in part on the communication protocol used to communicate the signal from the IoT device to the control device. In some embodiments, the predefined format is based at least in part on a template that is populated with the information included in the signal (e.g., device identifier, interface data, etc.). In some embodiments, the predefined format is based at least in part on the system within which the IoT device is deployed. For example, the IoT device can be preconfigured for use in a system of one or more IoT devices and one or more control devices, in which a system layer of the control device is leveraged to connect to the IoT device and to control at least one of the one or more IoT devices. The system layer of the control device can connect to the IoT device based on the system layer using interface data to connect to the IoT device. For example, a parsing engine of the system layer can parse the interface data and the system layer can establish a connection with the IoT device directly rather than having to invoke a native app associated with the IoT device to establish a connection with the IoT device to implement control with respect to the IoT device.

In some embodiments, the signal corresponds to information that is compressed according to one or more predefined compression technologies.

At 320, a device identifier (ID) is obtained based at least in part on the signal. In some embodiments, the control device obtains the device ID (e.g., in response to obtaining the signal). The device ID can be obtained from the signal. In some embodiments, the signal comprises information from which a device ID can be determined. For example, the control device can obtain information used to perform a lookup on a mapping of information to device ID in order to determine the device ID corresponding to the signal (e.g., the device ID of the IoT device that communicated the signal). The mapping can be stored locally at the control device or remotely at a terminal to which the control device can connect (e.g., a server, another terminal on the network, etc.). The device ID can be obtained based on information in the signal. For example, if the sender address of the signal is obtained from the signal (or a part of the signal such as the header of an information packet), and the sender address can be used to look up the device ID corresponding to the IoT device (e.g., the IoT device that sent the signal) based on a mapping of addresses to device IDs.

The control device can extract the device ID from the signal. For example, if the signal comprises information that is formatted according to a predefined format and/or using one or more compression technologies, the control device can extract the device ID based at least in part on the predefined format and/or the one or more compression technologies.

According to various embodiments, the device ID is unique with respect to a particular device (e.g., no other device at least within the system 100 has a same device ID. In some embodiments, the device ID represents one type of device (e.g., the device ID can be indicative of a type of device). For example, the device ID can be unique with respect to a particular type of device. The type of device can be set according to preferences or settings of the system in which the IoT device and control device are deployed, IoT device, or a user of IoT device. Types of devices can be differentiated according to device categories, different brands within the same category of device, device models corresponding to each brand, etc. Other characteristics pertaining to a device can be used to differentiate across types of the device. Thus, a type of device with the device ID can be determined based at least in part on the device ID, and data corresponding to the device can be obtained based at least in part on the type of device. For example, characteristics of the device can be obtained based at least on part on the device ID, or configuration settings for the device can be obtained, etc. The device ID can be a number value, a combination of alphanumeric characters and/or special characters, etc. The device ID can be a model number, a serial number, a manufacturer identifier, a Media Access Control (MAC) address, an Internet Protocol (IP) address, a Unique Device ID (UDID), a Global Unique Device ID (GUDID), etc.

At 330, interface data is obtained based at least in part on the device ID. In some embodiments, the control device obtains the interface data. The interface data can be obtained based at least in part on performing a look up of the interface data using the device ID. For example, the interface data is determined from mapping of interface data to device IDs, and the device ID corresponding to the signal is used to perform a lookup for the corresponding interface data. In some embodiments, the mapping of interface data to device IDs is stored locally at the control device. In some embodiments, the mapping of interface data to device IDs is stored remotely at a terminal to which the control device can connect (e.g., a server, another terminal on the network, etc.). The determining the interface data can include determining an identifier associated with the interface data, a location at which the interface data can be obtained, etc. In response to determining the interface data, the interface data can be obtained.

The interface data corresponding to the device ID can be obtained. For example, in response to determining the interface data corresponding to the device ID (e.g., the interface data mapped to the device ID), the corresponding interface data is obtained. The interface data can be stored locally (e.g., at the control device) or remotely at a terminal to which the control device can connect (e.g., a server, another terminal on the network, etc.). If the interface data is stored remotely, the obtaining the interface data can include sending a request for the interface data (e.g., to a server or a terminal on which the interface data is stored), and obtaining the interface data from the server or other terminal on which the interface data is stored or that manages storage of the interface data.

According to various embodiments, the interface data is used to describe a control interface of the IoT device. In some embodiments, the control interface is an interface that provides information pertaining to the IoT device (e.g., an operating status or other relevant information for the IoT device or service provided by the IoT device). In some embodiments, the control interface comprises one or more control elements with which a user can control the IoT device. For example, the user can input one or more settings, instructions, etc. using the control interface.

In some embodiments, the interface data includes information from which the control interface is determined. For example, the interface data comprises an identifier corresponding to the control interface. The control interface can be obtained based at least in part on the information from which the control interface is determined. For example, the control data can obtain the control interface locally or remotely based on the information from which the control interface is determined.

In some embodiments, the interface data comprises information defining one or more characteristics pertaining to the corresponding control interface. The one or more characteristics pertaining to the corresponding control interface can include layout information (e.g., indicating how to layout information and/or control elements on the control information), text information (e.g., text to be displayed), functionality information, etc. The functionality information can define one or more functions or instructions to be invoked in response to satisfaction of a condition. As an example, a condition upon satisfaction of which the one or more functions or instructions are invoked includes an input to the control interface. As an example, a condition upon satisfaction of which the one or more functions or instructions are invoked includes a determination that information obtained from an associated app (e.g., a weather app) satisfies one or more criteria (e.g., a current or forecasted temperature exceeding a threshold, etc.).

At 340, a control interface is provided. In some embodiments, the control device provides (e.g., displays) the control interface such as on a screen of the control device. The screen of the control device can be a touch screen. The control device provides the control interface based at least in part on the interface data.

In some embodiments, providing the control interface includes parsing the interface data. The interface data can be parsed in connection with configuring the control interface. For example, the information defining one or more characteristics pertaining to the corresponding control interface can be determined based on the interface data, and the control interface can be configured (e.g., generated) based at least in part on the information defining one or more characteristics pertaining to the corresponding control interface. The parsing of the interface data can include obtaining the information defining one or more characteristics pertaining to the corresponding control interface from the interface data. For example, the information defining one or more characteristics pertaining to the corresponding control interface can be obtained from the interface data based on a predefined format, a predefined template, a predefined compression technology, etc.

According to various embodiments, the control device establishes a connection with the IoT device based at least in part on the control interface. For example, in response to the user interacting with the control interface, the control device connects to the IoT device and communicates a corresponding command to the IoT device. If the user clicks a button on the control interface, the control device connects to the IoT device and communicates to the IoT device a command associated with the button.

According to various embodiments, the control device controls the IoT device based at least in part on the control interface. For example, the control device determines one or more instructions to control the IoT device and communicates the one or more instructions to the IoT device.

While operating, an IoT device can broadcast a signal via a wireless network such as Bluetooth or WiFi. The broadcasted signal can include the device ID. The signal (e.g., the device ID) is used in connection with notifying the control device that the IoT device is available to connect (e.g., waiting to connect). In response to receiving the signal, the control device analyzes the signal to obtain the device ID and to determine that the IoT device is available to connect. The control device can use the device ID to look up interface data of the corresponding IoT device. The interface data can be acquired locally or from a server. The control device then parses the interface data to obtain a control interface, which is displayed and used to control the IoT device based on one or more user interactions.

The control device can establish a connection with the corresponding IoT device on the basis of the control interface. Thus, in response to receiving the signal broadcast from an IoT device signal, a device ID is acquired from the signal, and the interface data of the corresponding IoT device is looked up according to the device ID. Accordingly, the signal communicated by the IoT device can be used to find the corresponding interface data, which can be parsed to obtain the control interface and to connect with the IoT device. Thus, an IoT device can be controlled according to interface data corresponding to the IoT device simply upon receipt of a signal (e.g., communicated from the IoT device). For example, the control device is not required to an install an app (e.g., an app associated with the IoT device) to control and/or communicate with the IoT device. Because the control device is not required to install an app with which to communicate and/or control the IoT device, fewer system resources are occupied.

FIG. 4 is a diagram of a system of devices and a connection of the devices to a terminal according to various embodiments of the present application.

Referring to FIG. 4, system 400 is provided. According to various embodiments, system 400 comprises IoT device 410 (e.g., a smart light), IoT device 420 (e.g., a smart appliance oven), IoT device 430 (e.g., a smart refrigerator), and IoT device 440 (e.g., an air-conditioning device), a control device 450, and/or a control device 460 (e.g., a mobile terminal such a tablet or a wearable device that is wearable by a user). FIG. 4 illustrates a connection between IoT devices 410-440 with control device 450 and/or control device 460. In some embodiments, control device 460 is a peripheral device that is connected to control device 450. For example, one or more of IoT devices 410-440 are controlled via control device 460 which communicates one or more instructions to the control device 460, which in turn communicates one or more instructions to the corresponding one or more IoT devices 410-440 to control such one or more IoT devices 410-440. In some embodiments, control device 460 directly communicates with the one or more IoT devices 410-440 (e.g., rather than serving as a peripheral device to control device 450).

System 400 can be implemented in connection with system 100 of FIG. 1, system 200 of FIG. 2, system 500 of FIG. 5, and/or parsing engine 600 of FIG. 6. System 400 can implement process 300 of FIG. 3, and/or process 700 of FIG. 7. System 400 can be implemented at least in part by computer system 800 of FIG. 8.

In some embodiments, one or more of IoT devices 410-440 and control device 450 and/or control device 460 are connected to a network and perform connection therebetween via the network.

According to one or more embodiments, control device 450 and control device 460 can run various platforms (e.g., operating systems, apps, etc.). Control device 450 and control device can run a same platform or a different platform.

An IoT device can issue a broadcast signal. In response to receiving the broadcasted signal, a control device uses a device ID in the signal as a basis to obtain corresponding interface data. For example, the control device parses the interface data and then displays the corresponding control interface and connects to the IoT device. Thus, the user can conveniently control IoT devices via a control interface on the control device and easily use various IoT devices.

FIG. 5 is a diagram of processing for management of an Internet of Things (IoT) device according to various embodiments of the present application.

Referring to FIG. 5, system 500 is provided. According to various embodiments, system 500 comprises control device 520 and IoT device 530. System 500 can further include server 510 and/or a third party platform 540. FIG. 1 illustrates a connection between IoT device 530 and control device 520. System 500 can be implemented in connection with system 100 of FIG. 1, system 200 of FIG. 2, system 400 of FIG. 4, and/or parsing engine 600 of FIG. 6. System 500 can implement process 300 of FIG. 3, and/or process 700 of FIG. 7. System 500 can be implemented at least in part by computer system 800 of FIG. 8.

According to various embodiments, control device 520 is connected to IoT device 530. For example, control device 520 is connected to IoT device 530 via one or more networks. As another example, control device 520 is connected to IoT device 530 via a communication channel established between control device 520 and IoT device 530 (e.g., a wireless connection or a direct wire link). As illustrated in FIG. 5, IOT device 530 can communicate (e.g., broadcast) a broadcast signal. Control device 520 can obtain the broadcast signal. As further illustrated in FIG. 5, a connection between control device 520 and IoT device is established.

In some embodiments, control device 520 is connected to server 510. Control device 520 can be connected to server 510 via one or more networks (e.g., the Internet, etc.). Control device 520 can communicate one or more requests to server 510. Server 510 can communicate information to control device 520. For example, server 510 provides to control device 520 information that is responsive to one or more requests received from control device 520. The one or more requests communicated by control device 520 to server 510 can include one or more queries pertaining to the IoT device. For example, the control device 520 queries the server 510 for interface data corresponding to a device ID that control device 520 obtains from the IoT device (e.g., a device ID included in the broadcast signal). As another example, the control device 520 queries server 510 for information to be used in connection with providing the control interface to the user, or in connection with controlling IoT device 530. Information to be used in connection with providing the control interface to the user, or in connection with controlling IoT device 530 can include contextual information or information associated with an app installed at control device 520. For example, server 530 can provide control device 520 with weather information (e.g., a current temperature, a forecasted temperature, a weather forecast, etc.) in connection with a control of an IoT device corresponding to an air-conditioning device.

According to various embodiments, server 510 is a platform that provides IoT device-related services. The platform for providing IoT device-related services can include one or more servers and be capable of maintaining the business logic corresponding to IoT devices and of providing service data, maintenance, and management services. For example, the platform provides IoT device-related services to control device 520 (e.g., in connection with control device 520 controlling IoT device 530).

In some embodiments, server 510 is connected to third party platform 540. Third party platform 540 can upload information to server 510. According to various embodiments, third party platform 540 is a service platform of a third party service provider. Third party service providers are third parties that provided embedded interfaces, such as independent software vendors (ISV). The third party platform 540 can provide interface data for IoT devices.

After a developer develops interface data for an IoT device, third party platform 540 can be used by the developer to upload the interface data to server 510. If a user deploys IoT device 530 and installs and runs IoT device 530, IoT device 530 can broadcast a signal. The signal can include the device ID corresponding to IoT device 530. Control device 520 can obtain the device ID based at least in part on (e.g., from) the signal broadcast by IoT device 530. In response to obtaining the device ID, control device 520 can use the device ID in connection with determining the interface data and/or control interface corresponding to IoT device 530. Control device 520 can use the device ID as a basis to request interface data from server 510. If control device 520 already has locally stored interface data (e.g., that was previously downloaded from server 510), then control device 520 will not need to repeat the request. In some embodiments, control device 520 determines whether a newer version (e.g., updated version) of the interface data is available at server 510, and if a newer version is available at server 510, control device 520 can obtain the newer version of the interface data. The interface data can be used to provide the control interface corresponding to IoT device 530 and/or to connect to IoT device 530. For example, after downloading and storing the interface data, control device 520 parses the interface data to display a control interface corresponding to IoT device 530 and establish a connection with IoT 530 device. After control device 520 and IoT device 530 are connected, control device 520 can control an operation of the IoT device 530. The method and system for enabling the user to control various IoT devices by using information in a signal communicated by IoT devices to provide a control interface and/or to establish a connection with the IoT device(s) facilitates an ease of deploying and controlling IoT devices.

According to various embodiments, a server can be queried for interface data corresponding to an IoT device. As an example, a control device can search the server for interface data corresponding to a particular IoT device (e.g., an IoT device that the control device wants to control). The server can store a mapping of device IDs to information associated with interface data. For example, the server stores a mapping of device IDs to identifiers for interface data. As another example, the server stores a mapping of device IDs to locations for interface data.

According to various embodiments, after a developer develops interface data (e.g., for an IoT device), a third party platform uploads the interface data to a server. The server can publish (or otherwise make accessible) the interface data. An example of interface data is shown in Table 1:

TABLE 1

| Key Field | Identifier | Explanation of Field |
|---|---|---|
| Device ID | id | Device-labeling unique ID for identifying |
| | | a corresponding device |
| Device name | name | Device name, whereby devices find and |
| | | search for each other |
| Service | desc | Detailed description of device for device |
| description | | look-up and display |
| Interface | markup | Description of the device control interface |
| description | | and control logic. Interface data written |
| language | | in markup may be rendered as a control |
| | | interface by a parsing engine and may |
| | | execute interactions. |

In some embodiments, the interface data includes information indicating a service that the corresponding IoT device provides, and/or information describing the service.

In some embodiments, the interface description language is a markup language (e.g., markup). Markup is a language based on Extensible Markup Language (XML) format that describes user interfaces (UI) and interactions. Accordingly, interface data can be generated on the basis of markup language. In some embodiments, interface data generated on the basis of markup language may describe an interface for connecting to and controlling an IoT device as well as related interactions on the interface. For example, the interface data can include information pertaining to one or more characteristics of the IoT device, a control of the IoT device, the control interface, and/or a communication with the IoT device. In some embodiments, the markup language is recognized by the system 500 (e.g., control device 520) and translated into instructions for generating an interface (e.g., a control interface) and actions (e.g., a functionality of the control interface such as a manner by which the IoT is controlled, information to be displayed on control interface, etc.).

The markup language, and rules and/or definitions for the markup language can be predefined and one or more third party service providers can use the markup language and corresponding rules and/or definitions to create interface data. For example, server 510 publishes writing rules and definitions for markup language in advance. A third party service provider (e.g., corresponding to third party platform 540) can thus acquire the markup language from the server and use the markup language definitions and write the interface data. According to various embodiments, interface data for an IoT device can be defined and written by using interface description language (e.g., markup). The interface data includes interface descriptive information (e.g., <layout>) and interaction descriptive information (e.g., <script>). The interface descriptive information (<layout>) is for describing the displayed interface. Operating status data (<data>) is for describing the control logic of the IoT device. For example, the operating status describes the logic of user taps on the interface or other interactions and corresponding response logic. For example, controls such as <CompositeView/>, <TextView/>, and <Button/> are used to respond to user operations. For example, an air-conditioning device (e.g., that is an IoT device) can be connected to a control device through the script language provided in <script> and the corresponding air-conditioning API. Accordingly, the control device can obtain real-time temperature and fan speed of the air-conditioning device and display the information on the interface. A user can use the control device to control the air-conditioning temperature and/or fan speed directly through controls on the control interface provided on the control device.

FIG. 6 is a diagram of a parsing engine according to various embodiments of the present application.

Referring to FIG. 6, parsing engine 600 is provided. According to various embodiments, parsing engine 600 can be implemented in by system 100 of FIG. 1, system 200 of FIG. 2, system 400 of FIG. 4, and/or system 500 of FIG. 5. Parsing engine 600 can implement at least part of process 300 of FIG. 3, and/or process 700 of FIG. 7. Parsing engine 600 can be implemented at least in part by computer system 800 of FIG. 8.

In some embodiments, a terminal (e.g., a control device) is configured with parsing engine 600. The parsing engine 600 can be used to interface data. For example, in response to receiving the interface data corresponding to a device ID (e.g., a device ID obtained from a signal communicated by an IoT device), the control device uses the parsing engine 600 to parse the interface data. According to various embodiments, the control device uses parsing engine 600 in connection with determining (e.g., generating) the control interface.

Parsing engine 600 (markup engine) parses interface data written in an interface description language (markup). As an example, parsing engine 600 is an engine that parses interfaces and calls the operating system Graphical User Interface (GUI) framework to generate User Interfaces (UIs). Accordingly, in response to obtaining interface data, parsing engine 600 is used to render the interface data into UIs.

According to various embodiments, parsing engine 600 includes one or more sub-parsing engines. For example, parsing engine 600 includes: a first parsing engine (not shown), a second parsing engine 610, and a third parsing engine (not shown). The various sub-parsing engines can be used in connection with parsing different information. The first parsing engine can parse interface descriptive information, the second parsing engine can map to UI controls and generate a control interface, and the third parsing engine can respond to the control logic to control IoT devices.

The first parsing engine can also be referred to as a markup parser. The first parsing engine is used to parse interface data such as markup text (e.g., interface descriptive information written in markup language). The first parsing engine can parse XML-based markup text into structured data. For example, the first parsing engine creates structured data based at least in part on XML-based markup text comprised in the interface data. The parsing engine makes the structured data available for subsequent generation of UIs and interaction scripts.

Second parsing engine 610 can be referred to as a UI renderer. According to various embodiments, second parsing engine 610 is used to convert UI elements included in markup <layout> into UI controls in operating systems corresponding to various smart terminals (e.g., control devices) and to generate corresponding UIs. According to various embodiments, a rendering engine is created for each different operating system on various mobile platforms. The rendering engine can be a sub-component of the second parsing engine 610. The rendering engine can map each UI element in markup to a UI control on a mobile platform. Thus, UI renderer 610 can be used to generate the UIs in various supported operating systems based at least in part on the description of the UIs provided markup. As an example, a positioning and navigation interface is provided in an Android system. As shown in FIG. 6, the UI elements CompositeView, TextView, TextField, and Button in markup are mapped through UI Renderer 610 to the UI controls ViewGroup, TextView, ExitText, and Button, respectively, in the Android system.

The third parsing engine can be referred to as a script engine. The third parsing engine is a runtime environment provided for execution of JavaScript scripts contained in <script>. The runtime environment is composed of V8 and nodes (e.g., engines of AliOS). Scripts defined in markup can be executed via the JavaScript runtime environment when a control interface is rendered. For example, the scripts defined in the markup are executed in connection with rendering of the control interface to provide logic in the control interface. According to various embodiments, the third parsing engine uses JavaScript to parse and respond to control logic information.

FIG. 7 is a flowchart method for controlling a device according to various embodiments of the present application.

Referring to FIG. 7, process 700 is provided. According to various embodiments, system 100 comprises IoT device 110 and control device 120. FIG. 1 illustrates a connection between IoT device 210 and control device 220. System 100 can be implemented in connection with system 200 of FIG. 2, system 400 of FIG. 4, system 500 of FIG. 5, and/or parsing engine 600 of FIG. 6. System 100 can implement process 300 of FIG. 3, and/or process 700 of FIG. 7. System 100 can be implemented at least in part by computer system 800 of FIG. 8.

In some embodiments, process 700 is implemented by a control device (e.g., a device that controls an IoT device).

At 702, a device ID is obtained based at least in part on a signal received from an IoT device. In some embodiments, a control device receives the signal from the IoT device. In some embodiments, the control device obtains the signal via a broadcast signal. For example, the IoT device can broadcast the signal, and the control device can monitor for broadcasted signals and obtain the signal (e.g., upon detecting the broadcasted signal). As another example, the IoT device communicates the signal via an established connection between the IoT device and the control device.

The device ID is obtained based at least in part on the signal. In some embodiments, the control device obtains the device ID (e.g., in response to obtaining the signal). The device ID can be obtained from the signal. In some embodiments, the signal comprises information from which a device ID can be determined. For example, the control device can obtain information used to perform a lookup on a mapping of information to device ID in order to determine the device ID corresponding to the signal (e.g., the device ID of the IoT device that communicated the signal). The mapping can be stored locally at the control device or remotely at a terminal to which the control device can connect (e.g., a server, another terminal on the network, etc.). An example of the device ID being obtained based on information in the signal is if the sender address of the signal is obtained from the signal (or a part of the signal such as the header of an information packet) and the sender address is used to look up the device ID corresponding to the IoT device (e.g., the IoT device that sent the signal) based on a mapping of addresses to device IDs.

The control device can extract the device ID from the signal. For example, if the signal comprises information that is formatted according to a predefined format and/or using one or more compression technologies, the control device can extract the device ID based at least in part on the predefined format and/or the one or more compression technologies.

According to various embodiments, interface data is obtained based at least in part on the device ID. The control device can obtain the interface data. The interface data can be obtained based at least in part on performing a look up of the interface data using the device ID. For example, the interface data is determined from mapping of interface data to device IDs, and the device ID corresponding to the signal is used to perform a lookup for the corresponding interface data. In some embodiments, the mapping of interface data to device IDs is stored locally at the control device. In some embodiments, the mapping of interface data to device IDs is stored remotely at a terminal to which the control device can connect (e.g., a server, another terminal on the network, etc.). The determining the interface data can include determining an identifier associated with the interface data, a location at which the interface data can be obtained, etc. In response to determining the interface data, the interface data can be obtained.

The interface data corresponding to the device ID can be obtained. For example, in response to determining the interface data corresponding to the device ID (e.g., the interface data mapped to the device ID), the corresponding interface data is obtained. The interface data can be stored locally (e.g., at the control device) or remotely at a terminal to which the control device can connect (e.g., a server, another terminal on the network, etc.). If the interface data is stored remotely, the obtaining the interface data can include sending a request for the interface data (e.g., to a server or a terminal on which the interface data is stored), and obtaining the interface data from the server or other terminal on which the interface data is stored or that manages storage of the interface data.

IoT devices can connect externally via wireless networks such as Bluetooth or WiFi. IoT devices can broadcast signals via wireless networks such as Bluetooth or WiFi. An IoT device can add a device ID for the IoT device to the signal being broadcast. The device ID corresponds to a device ID of the interface data uploaded to the server. As an example, after automatically scanning and detecting a Bluetooth or WiFi broadcast signal, the operating system of the control device automatically analyzes the broadcast signal to obtain the device ID included in the signal. Thus, the control device can become aware of the IoT device via a broadcast signal and can determine the particular device ID corresponding to the IoT device.

Accordingly, the control device can use the device ID as a basis to obtain interface data of the corresponding IoT device. In some embodiments, the control device locally looks up the interface data of the IoT device corresponding to the device ID and/or download from the server the interface data of the IoT device corresponding to the device ID. For example, based on the device ID, the control device determines if the interface data exists locally, and can send a request to the server to download the interface data corresponding to the device ID.

At 704, a determination is made as to whether interface data is locally stored. In some embodiments, the control device determines whether the interface data corresponding to the ID data is stored locally at the control device. For example, the control device queries a mapping of interface data (or information identifying interface data) to device IDs in connection with determining whether the interface data corresponding to the device ID is stored locally.

In response to determining that interface data is not locally stored, process 700 proceeds to 706. At 706, interface data is requested based at least in part on the device ID. In some embodiments, in response to determining that the interface data is not locally stored, a request for interface data is generated based at least in part on the device ID. For example, the control device generates the request for the interface data. The request for the interface data is communicated to a server. For example, the control device communicates the request for interface data to a server to which the control device is connected (e.g., via one or more networks) and that provides a service of providing interface data for IoT devices. For example, the server can manage interface data for IoT devices. Third party developers can provide the server with interface data for IoT devices developed by the third party developer.

At 708, interface data is obtained from the server. In some embodiments, the server communicates the interface data in response to receiving the request for interface data. The interface data communicated by the server corresponds to the device ID (e.g., the device ID included in the request communicated by the control device). The control device can receive the interface data corresponding to the device ID from the server, and in response to receiving the interface data, the control device stores the interface data. For example, the control device stores the interface data locally at the control device.

In response to receiving the request for the interface data, the server can obtain the device ID for the IoT device for which interface data is being requested. In response to obtaining the device ID, the server performs a lookup with respect interface data corresponding to the device ID. If the server determines that interface data corresponding to the device ID is stored, the server communicates the interface data (e.g., to the control device from which the request was received).

In response to the interface data being obtained from the server, process 700 proceeds to 710.

In response to determining that interface data is locally stored, process 700 also proceeds to 710.

At 710, UI elements corresponding to the interface data are obtained. In some embodiments, the control device obtains the UI elements in connection with generating a control interface and/or connecting to the IoT device corresponding to the device ID. In some embodiments, the UI elements are obtained based at least in part on a parsing of the interface data. For example, a parsing engine of the control device can obtain the UI elements.

According to various embodiments, second parsing engine 610 of parsing engine 600 of FIG. 6 obtains the UI elements corresponding to the interface data. In some embodiments, the parsing engine obtains the UI elements based on the interface data being provided according to a predefined markup.

At 712, a control interface is generated based at least in part on one or more UI elements, and the control interface is provided. In some embodiments, the control device provides the control interface via a display on the screen. In response to parsing the interface data to obtain the UI element(s), the control device generates the control interface. The control interface can be used to connect to the IoT device and/or to control the IoT device via the control device (e.g., based on a user input, based on information obtained by an app, based on a context, etc.).

In some embodiments, the control interface is generated/configured based at least in part on the UI element(s) and control logic information.

At 714, control logic information is obtained based at least in part on the interface data, and the control device connects to the IoT device. In some embodiments, the control device obtains the control logic information in response to obtaining the interface data. The control logic information can be obtained based at least in parsing the interface data. For example, a parsing engine of the control device can obtain the control logic information.

According to various embodiments, the control device connects to the IoT device based at least in part on the control interface and the control logic information. The control logic information can describe one or more functions or instructions by which the IoT device can be controlled or by which a connection with the IoT device can be established. The control logic information can correspond to the logic for controlling an TOT device using the control interface (e.g., logic associated with selection of a button, etc. on the control interface).

In some embodiments, in response to obtaining the interface data, the interface data is parsed to obtain the UI elements to be used in connection with providing the control interface, and the control interface is generated by determining one or more UI controls corresponding to the UI element(s). After the control interface is generated, the control device displays the control interface. According to various embodiments, the generating and displaying the control interface can include parsing the interface data to determine scripts corresponding to the control interface and to execute a connection process based at least in part on scripts to establish a connection with the corresponding IoT device. The determination of the scripts used to establish a connection with the IoT device and the connection with the IoT device enables subsequent control of the IoT device.

The parsing of the interface data to generate a control interface and displaying the control interface can include calling a parsing engine to parse (e.g., convert) the interface descriptive information into structured data, and determining one or more UI elements according to the structured data. The parsing of the interface data to generate a control interface and displaying the control interface can further include parsing the one or more UI elements into corresponding UI controls, and using the UI controls to generate a corresponding control interface.

A first parsing engine can be called to parse interface descriptive information. The first parsing engine parses the interface descriptive information into structured data. The control device (e.g., the first parsing engine) can generate UI scripts and/or interaction scripts based on the structured data. Then a second parsing engine uses the structured data as a basis to determine UI elements in the <layout> portion written in markup language. The second parsing engine can map the UI elements to UI controls needed in the control interface and can generate the corresponding control interface.

In some embodiments, control logic information is determined based on the interface data. A connection with the IoT device is established based at least in part on the control interface and the interface control logic information. As an example, the scripts corresponding to the control interface are determined based at least in part on the control logic information, and the scripts are used to look up the corresponding IoT device and to connect with the IoT device. In some embodiments, in connection with rendering the control interface, a third parsing engine is used to execute scripts defined in the corresponding interface data. The scripts can be used to look up the corresponding IoT device, and a request is issued to the IoT device to establish a connection.

According to various embodiments, the use of control interface and control logic information connection with connecting to an IoT device includes: the control interface calling an interface according to control logic information to look up the IoT device corresponding to a connection ID, sending a connection request to the IoT device. The connection ID can be obtained based at least in part on the interface data corresponding to the IoT device. As an example, a script calls an interface to look up the corresponding IoT device according to a connection ID, and a connection request is sent to the IoT device. In some embodiments, a script corresponding to the interface data is executed, and a connection ID is obtained from the script. The connection ID is used to connect to the IoT device. The connection ID can serve as a basis to call the corresponding interface (e.g., the control interface) to look up the IoT device and generate a corresponding connection request, which is sent to the IoT device. A connection is thus established with the IoT device.

According to various embodiments, the IoT device provides information to the control device when the control device is connected to the IoT device. For example, the IoT device provides information pertaining to status of the IoT device (e.g., an operating status such a status of one or more functions of the IoT device). The IoT device can provide the control device with context information such as information pertaining to an environment around the IoT device, etc. As an example, the context information is determined based at least in part on information obtained from one or more sensors of the IoT device. As another example, the context information is determined based at least in part on information obtained by the IoT device from one or more terminals to which the IoT is connected (e.g., a server, another IoT device, a terminal connected to one or more networks to which the IOT device is connected, etc.).

Status data can be received as feedback from the IoT device, and corresponding statuses are displayed (e.g., at the control device) according to the status data in the control interface. After the control device successfully connects to the IoT device, a callback function can be executed to obtain IoT device status data. The status data is then parsed (e.g., by the control device) to obtain real-time statuses of the IoT device and to display the corresponding statuses on the control interface. For example, the real-time status data of an air-conditioning device is acquired (e.g., by the control device such as via the control interface of the control device), and then the corresponding temperature and fan speed are displayed on the control interface. As another example, in response to obtaining refrigerator status data (e.g., from an IoT device that is a smart refrigerator), a current storage temperature and storage status of the refrigerator can be displayed. A complete connection and control API can be set up in advance for an IoT device so that device connection and control can be implemented on the basis of this API.

At 716, an IoT device is controlled based at least in part on instruction information. In some embodiments, the control device can communicate to the IoT one or more instructions (or requests) based on the instruction information. In response to receiving the one or more instructions, the IoT device performs one or more corresponding operation (e.g., a control operation).

According to various embodiments, the instruction information is obtained by the control interface. As an example, the instruction information is obtained (e.g., generated) in response to a user input to the control device. The user input to the control device can be an input using one or more control elements provided on the control interface. As another example, the instruction information is obtained based at least in part on information received from one or more apps on the control device. The apps can obtain information from one or more servers or from one or more sensors on the control device, and the apps can provide the information (e.g., context information) to the control interface.

In the case of an IoT device that is an air-conditioning device (or a climate controlling device such as a heating/cooling device), a weather app can obtain weather information from one or more servers providing weather service, and the weather app can provide the weather information to the control interface. In response to receiving the weather information, the control interface can determine instruction information based at least in part on the weather information and/or status information pertaining to the IoT device.

In the case of an IoT device that is a refrigerator, a grocery app can obtain order information from one or more servers providing a grocery ordering service, and the grocery app can provide the order information to the control interface. In response to receiving the grocery information, the control interface can provide information pertaining to a status of a grocery order. The control interface can update a status (e.g., an inventory) of the refrigerator based at least in part on the grocery order.

In some embodiments, scripts are called based at least in part on the instruction information, and then the scripts are used to execute the corresponding control operations. As an example, after the control interface is displayed, the IoT device is controlled according to the control interface (e.g., based at least in part on one or more user inputs, etc.). The user can select a desired operation on the control interface (e.g., by inputting an input with respect to one or more of the control elements provided on the control interface). As an example, the user can issue instruction information by triggering a control on the control interface. In response to the triggering of the control (e.g., an input with respect to one or more control elements), a script corresponding to the control interface is called based at least in part on the instruction information. In some embodiments, the script is used to determine an ID and a handle corresponding to the instruction information and to call the corresponding API to execute a corresponding control operation. The control operation can be determined based on the ID corresponding to the instruction information. Accordingly, the user can implement control over the IoT device via the control interface (e.g., controlling air-conditioning temperature and fan speed by controlling the temperature increase (decrease) handle and the fan speed decrease (increase) handle).

According to various embodiments, the system layer provides capabilities for quick (and seamless) connection and for control of various types of IoT devices. IoT device developers can develop and publish features for controlling IoT devices based on the capabilities provided by the system layer. As an example, the features developed for IoT devices using the capabilities provided by the system layer implementation achieve native app experience and performance. A control device can quickly connect to and control an IoT device as necessary without having to install an app in the application layer, thereby resulting in fewer resources occupied because of app installation in the application layer. For example, capabilities based on the system layer implementation layer are carried out at least in part by a parsing engine. Thus, after a developer develops the interface data, the interface data is provided to the control device in response to the control device detecting a signal broadcast by the IoT device. In response to obtaining the interface data, the interface data can be parsed by the parsing engine and displayed as an interface without having to undergo an installation process in the control device (e.g., a terminal). Moreover, device control and interaction can be implemented through the interface and corresponding script.

Please note that all the method embodiments have been presented as a series of a combination of actions in order to simplify description. However, persons skilled in the art should know that embodiments of the present application are not limited by the action sequences that are described, for some of the steps may make use of another sequence or be implemented simultaneously in accordance with embodiments of the present application. Secondly, persons skilled in the art should also know that the embodiments described in the specification are all preferred embodiments. The actions that they involve are not necessarily required by embodiments of the present application.

FIG. 8 is a functional diagram of a computer system according to various embodiments of the present application.

Referring to FIG. 8, computer system 800 is provided. Computer system 800 can implement at least part of system 100 of FIG. 1, system 200 of FIG. 2, system 400 of FIG. 4, system 500 of FIG. 5, and/or parsing engine 600 of FIG. 6. Computer system 800 can implement at least part of process 300 of FIG. 3, and/or process 700 of FIG. 7.

Processor 802 is coupled bi-directionally with memory 810, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also as is well known in the art, primary storage typically includes basic operating instructions, program code, data, and objects used by the processor 802 to perform its functions (e.g., programmed instructions). For example, memory 810 can include any suitable computer-readable storage media, described below, depending on whether, for example, data access needs to be bi-directional or uni-directional. For example, processor 802 can also directly and very rapidly retrieve and store frequently needed data in a cache memory (not shown). The memory can be a non-transitory computer-readable storage medium.

A removable mass storage device 812 provides additional data storage capacity for the computer system 800, and is coupled either bi-directionally (read/write) or uni-directionally (read only) to processor 802. For example, storage 812 can also include computer-readable media such as magnetic tape, flash memory, PC-CARDS, portable mass storage devices, holographic storage devices, and other storage devices. A fixed mass storage 820 can also, for example, provide additional data storage capacity. The most common example of mass storage 820 is a hard disk drive. Mass storage device 812 and fixed mass storage 820 generally store additional programming instructions, data, and the like that typically are not in active use by the processor 802. It will be appreciated that the information retained within mass storage device 812 and fixed mass storage 820 can be incorporated, if needed, in standard fashion as part of memory 810 (e.g., RAM) as virtual memory.

In addition to providing processor 802 access to storage subsystems, bus 814 can also be used to provide access to other subsystems and devices. As shown, these can include a display monitor 818, a network interface 816, a keyboard 804, and a pointing device 806, as well as an auxiliary input/output device interface, a sound card, speakers, and other subsystems as needed. For example, the pointing device 806 can be a mouse, stylus, track ball, or tablet, and is useful for interacting with a graphical user interface.

The network interface 816 allows processor 802 to be coupled to another computer, computer network, or telecommunications network using a network connection as shown. For example, through the network interface 816, the processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect the computer system 800 to an external network and transfer data according to standard protocols. For example, various process embodiments disclosed herein can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

An auxiliary I/O device interface (not shown) can be used in conjunction with computer system 800. The auxiliary I/O device interface can include general and customized interfaces that allow the processor 802 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 8 is but an example of a computer system suitable for use with the various embodiments disclosed herein. Other computer systems suitable for such use can include additional or fewer subsystems. In addition, bus 814 is illustrative of any interconnection scheme serving to link the subsystems. Other computer architectures having different configurations of subsystems can also be utilized.

The systems, means, modules, or units illustrated by the above embodiments specifically may be implemented by computer chips or entities or by products having certain functions. A typical implementing device is a computer. The particular form a computer may take may be a personal computer, laptop computer, cellular phone, camera phone, smart phone, personal digital assistant, media player, navigation device, email receiving device, game console, tablet computer, wearable device, or a combination of any of these devices.

In a typical configuration, a computer comprises one or more processors (CPUs), input/output ports, network interfaces, and memory.

Memory may include the following forms in computer-readable media: volatile memory, random access memory (RAM), and/or non-volatile memory, e.g., read-only memory (ROM) or flash RAM. Memory is an example of a computer-readable medium.

Each of the embodiments contained in this specification is described in a progressive manner. The explanation of each embodiment focuses on areas of difference from the other embodiments, and the descriptions thereof may be mutually referenced regarding portions of each embodiment that are identical or similar.

A person skilled in the art should understand that an embodiment of the present application may provide methods, devices, or computer program products. Therefore, the embodiments of the present application may take the form of embodiments that are entirely hardware, embodiments that are entirely software, and embodiments that combine hardware and software aspects. Moreover, an embodiment of the present application may take the form of one or more computer program products implemented on computer-usable storage media (including but not limited to magnetic disk memory, CD-ROM, and optical memory) containing computer-usable program code.

In one typical configuration, said computer equipment comprises one or more processors (CPUs), input/output interfaces, network interfaces, and memory. Memory may include such forms as volatile memory in computer-readable media, random access memory (RAM) and/or non-volatile memory, such as read-only memory (ROM) or flash memory (flash RAM). Memory is an example of a computer-readable medium. Computer-readable media, including permanent and non-permanent and removable and non-removable media, may achieve information storage by any method or technology. The information may be computer-readable instructions, data structures, program modules, or other data. Examples of computer storage media include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk-read only memory (CD-ROM), digital versatile disk (DVD) or other optical storage, cassette tapes, magnetic tape and disk storage or other magnetic storage devices, or any other non-transmitting media that may be used to store computer-accessible information. In accordance with the definitions in this document, computer-readable media does not include transitory computer-readable media (transitory media) such as modulated data signals and carrier waves.

The embodiments of the present application are described with reference to flowcharts and/or block diagrams based on methods, terminal devices (systems), and computer program products of the embodiments of the present application. Please note that each process and/or block within the flowcharts and/or block diagrams and combinations of processes and/or blocks within the flowcharts and/or block diagrams can be implemented by computer instructions. These computer program commands can be provided to the processors of general-purpose computers, specialized computers, embedded processor devices, or other programmable data-processing terminals to produce a machine. The commands executed by the processors of the computers or other programmable data-processing terminal devices consequently give rise to means for implementing the functions specified in one or more processes in the flowcharts and/or one or more blocks in the block diagrams.

These computer program commands can also be stored in computer-readable memory that can guide the computers or other programmable data-processing terminal equipment to operate in a specific manner. As a result, the commands stored in the computer-readable memory give rise to products including command devices. These command devices implement the functions specified in one or more processes in the flowcharts and/or one or more blocks in the block diagrams.

These computer program commands can also be loaded onto computers or other programmable data-processing terminal devices and made to execute a series of steps on the computers or other programmable data-processing terminal devices so as to give rise to computer-implemented processing. The commands executed on the computers or other programmable data-processing terminal devices thereby provide the steps of the functions specified in one or more processes in the flowcharts and/or one or more blocks in the block diagrams.

Although preferred embodiments of the present application have already been described, persons skilled in the art can make other modifications or revisions to these embodiments once they grasp the basic creative concept. Therefore, the attached claims are to be interpreted as including the preferred embodiments as well as all modifications and revisions falling within the scope of the embodiments of the present application.

Lastly, it must also be explained that, in this document, relational terms such as “first” or “second” are used only to differentiate between one entity or operation and another entity or operation, without necessitating or implying that there is any such actual relationship or sequence between these entities or operations. Moreover, the term “comprise” or “contain” or any of their variants are to be taken in their non-exclusive sense. Thus, processes, methods, things, or terminal devices that comprise a series of elements not only comprise those elements, but also comprise other elements that have not been explicitly listed or elements that are intrinsic to such processes, methods, things, or terminal devices. In the absence of further limitations, elements that are limited by the phrase “comprises a(n) . . . ” do not exclude the existence of additional identical elements in processes, methods, things, or terminal devices that comprise said elements.

Detailed introductions were provided above to a device-associating method, a device-associating means, a terminal device, and an Internet of Things-based operating system provided by the present application. This document has applied specific examples to explain the principles and implementations of the present application. The above descriptions of the embodiments are only for the purpose of aiding the understanding of the methods and core concepts of the present application. A person with ordinary skill in the art will always be able to make modifications in keeping with the idea of the present application to specific embodiments and scopes of application. The content of this specification should not be understood as limiting the present application.

Although the foregoing embodiments have been described in some detail for purposes of clarity of understanding, the invention is not limited to the details provided. There are many alternative ways of implementing the invention. The disclosed embodiments are illustrative and not restrictive.

1. A method, comprising:
receiving a signal from an Internet of Things (IoT) device;
obtaining a device identifier (ID) based at least in part on the signal;
determining interface data corresponding to the IoT device based at least in part on the device ID; and
providing a control interface that is configured to control the IoT device, the control interface being provided based at least in part on the interface data.

2. The method of claim 1, wherein the interface data provides a definition with respect to one or more characteristics of the control interface.

3. The method of claim 1, wherein the providing of the control interface based at least in part on the interface data comprises parsing the interface data and creating the control interface based at least on information parsed from the interface data.

4. The method of claim 1, further comprising:
obtaining, by the control interface, instruction information based at least in part on information obtained by the control interface; and
controlling, by the control interface, the IoT device based at least in part on the instruction information.

5. The method of claim 4, wherein the controlling of the IoT device comprises communicating one or more instructions to the IoT device based at least in part on the instruction information.

6. The method of claim 4, wherein the instruction information is obtained based at least in part on one or more user inputs with respect to one or more control elements provided on the control interface.

7. The method of claim 1, wherein the determining of the interface data corresponding to the IoT device based at least in part on the device ID comprises:
querying a local storage in connection with determining whether interface data corresponding to the IoT device corresponding to the device ID is stored locally; or
obtaining, from a server, the interface data corresponding to the IoT device based at least in part on the device ID.

8. The method of claim 1, wherein the determining of the interface data corresponding to the IoT device based at least in part on the device ID comprises:
generating a data request based at least in part on the device ID;
communicating the data request to a server;
receiving the interface data communicated by the server, wherein the interface data was looked up at the server based at least in part on the device ID; and
storing the interface data.

9. The method of claim 1, wherein the receiving of the signal from the IoT device comprises:
receiving the signal via a broadcast, wherein the broadcast is issued through Bluetooth, WiFi, or both.

10. The method of claim 1, wherein the providing of the control interface based at least in is part on the interface data comprises parsing the interface data and creating the control interface based at least on information parsed from the interface data, and the parsing the interface data and generating the control interface comprises:
parsing the interface data to obtain one or more corresponding User Interface (UI) elements; and
generating the control interface based at least in part on the one or more corresponding UI elements.

11. The method of claim 10, wherein the parsing of the interface data to obtain the one or more corresponding UI elements comprises:
calling a parsing engine to parse interface descriptive information included in the interface data into structured data; and
determining the one or more corresponding UI elements based at least in part on the structured data.

12. The method of claim 10, wherein the generating of the control interface based at least in part on the one or more corresponding UI elements comprises:
parsing the one or more UI elements into one or more corresponding UI controls; and
generating the corresponding control interface.

13. The method of claim 1, further comprising:
determining control logic information based at least in part on the interface data; and
connecting to the IoT device based at least in part on the control interface and the control logic information.

14. The method of claim 13, wherein the connecting to the IoT device based at least in part on the control interface and the control logic information comprises:
calling, by the control interface, an interface according to the control logic information to look up the IoT device corresponding to a connection ID, the connection ID being based at least in part on the interface data; and
sending, by the control device, a connection request to the IoT device.

15. The method of claim 1, further comprising:
receiving status data as feedback from the IoT device after a connection is established between the control device and the IoT device; and
displaying corresponding statuses in the control interface, the corresponding statuses being based at least in part on the status data.

16. A device, comprising:
one or more processors configured to:
receive a signal from an Internet of Things (IoT) device;
obtain a device identifier (ID) based at least in part on the signal;
determine interface data corresponding to the IoT device based at least in part on the device ID; and
provide a control interface that is configured to control the IoT device, the control interface being provided based at least in part on the interface data; and
one or more memories coupled to the one or more processors, configured to provide the one or more processors with instructions.

17. The device of claim 16, wherein the interface data provides a definition with respect to one or more characteristics of the control interface.

18. The device of claim 16, wherein the providing of the control interface based at least in part on the interface data comprises parsing the interface data and creating the control interface based at least on information parsed from the interface data.

19. The device of claim 16, wherein the one or more processors are further configured to
obtain, by the control interface, instruction information based at least in part on information obtained by the control interface; and
control, by the control interface, the IoT device based at least in part on the instruction information.

20. A computer program product, the computer program product being embodied in a non-transitory computer readable storage medium and comprising computer instructions for:
receiving a signal from an Internet of Things (IoT) device;
obtaining a device identifier (ID) based at least in part on the signal;
determining interface data corresponding to the IoT device based at least in part on the device ID; and
providing a control interface that is configured to control the IoT device, the control interface being provided based at least in part on the interface data.
